(19) United States
(12) Patent Application Publication
(10) Pub. No.: US 2021/0378402 A1
(43) Pub. Date: Dec. 9, 2021

(54) SUPPORT STAND AND CABINET WITH SUPPORT STAND

(71) Applicant: HONGFUJIN PRECISION ELECTRONICS(TIANJIN)CO.,LTD., Tianjin (CN)

(72) Inventors: CHIH-FENG CHANG, Tu-Cheng (TW); HUNG-LIANG CHUNG, New Taipei (TW); KUO-CHIH HUNG, New Taipei (TW)

(21) Appl. No.: 17/029,336

(22) Filed: Sep. 23, 2020

(30) Foreign Application Priority Data
Jun. 9, 2020 (CN) 202010518759.4

(51) Int. Cl. A47B 91/02

(52) U.S. Cl. CPC A47B 91/024; A47B 2230/0003

(57) ABSTRACT

A support stand includes a fixing base, a support leg penetrating through the fixing base, a housing assembly accommodating the fixing base, a first gear rotationally sleeved on the support leg and resisting against the fixing base, and a second gear rotationally mounted between the housing assembly and the fixing base. The first gear is meshed with the second gear. The second gear is provided with an operating portion for rotating the second gear and driving the first gear to rotate, so as to make the first gear move on the support leg and drive the fixing base to move on the support leg.

### FIELD

The subject matter herein generally relates to cabinets, and more particularly to a support stand for adjusting a height of a cabinet.

### BACKGROUND

A cabinet is used to house electrical or electronic equipment. Generally, an adjustable support stand is installed on a bottom of the cabinet, and an adjustment nut is arranged above the support leg to adjust a height of the cabinet. The adjustment nut is operated by a wrench to adjust the height of the support leg. However, when multiple cabinets are arranged side-by-side, the adjustment nut may not be able to be operated by the wrench due to space constraints.

### BRIEF DESCRIPTION OF THE DRAWINGS

Implementations of the present disclosure will now be described, by way of embodiments, with reference to the attached figures.

FIG. 1 is a schematic perspective diagram of an embodiment of a support stand.

FIG. 2 is an exploded schematic diagram of the support stand in FIG. 1.

FIG. 3 is similar to FIG. 2, but shown from another angle.

FIG. 4 is a schematic perspective diagram of an embodiment of a cabinet.

FIG. 5 is an enlarged view of circled portion V in FIG. 4.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

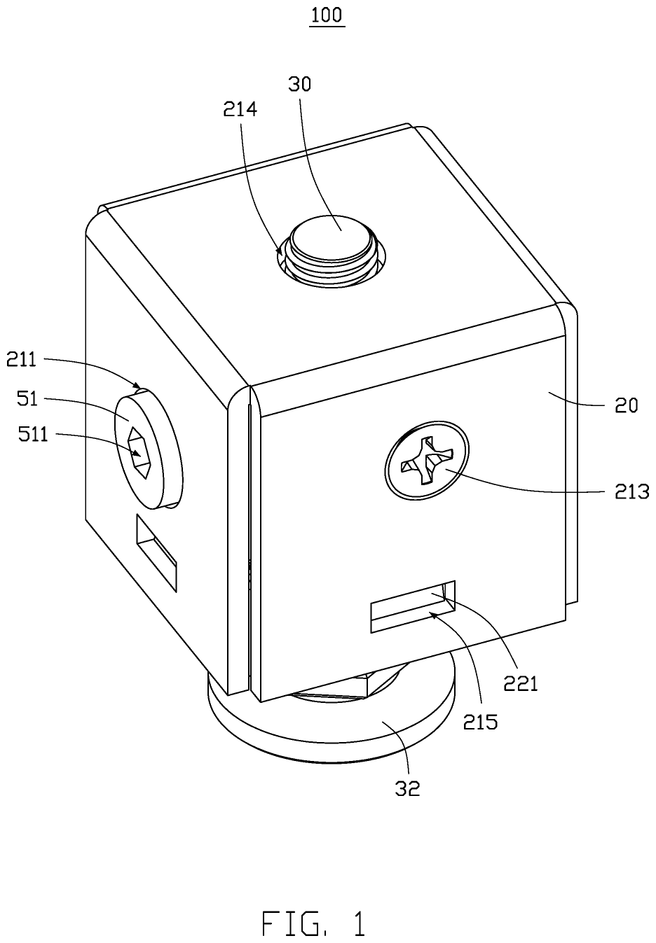

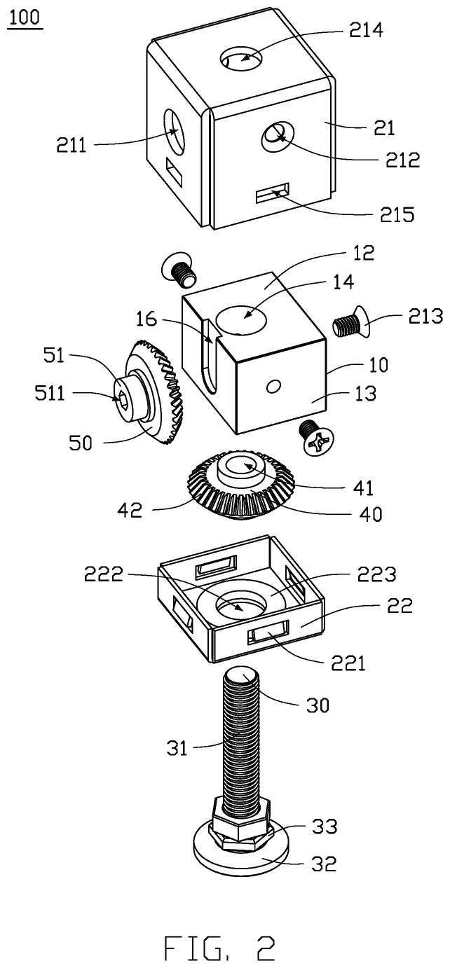

FIGS. 1 and 2 show an embodiment of a support stand 100 includes a fixing base 10, a housing assembly 20, a support leg 30, a first gear 40, and a second gear 50. The fixing base 10 is installed in the housing assembly 20, and the support leg 30 penetrates through the fixing base 10. The first gear 40 is sleeved on the support leg 30 and resists against the fixing base 10. The second gear 50 is rotationally mounted between the housing assembly 20 and the fixing base 10. An inside of the first gear 40 is meshed with the support leg 30, and an outside of the first gear 40 is meshed with the second gear 50. Rotating the second gear 50 drives the first gear 40 to rotate, thereby driving the fixing base 10 to move on the support leg 30, thereby adjusting a height of the support stand 100.

The fixing base 10 includes a bottom surface 11 and a top surface 12. The bottom surface 11 is opposite to the top surface 12. A plurality of side surfaces 13 is arranged between the bottom surface 11 and the top surface 12. Planes of the side surfaces 13 are substantially perpendicular to a plane of the bottom surface 11. The fixing base 10 defines a shaft hole 14 in the bottom surface 11 and the top surface 12 for passing through the support leg 30. In one embodiment, an axis of the shaft hole 14 is substantially perpendicular to the bottom surface 11. In one embodiment, the fixing base 10 is substantially a rectangular parallelepiped structure.

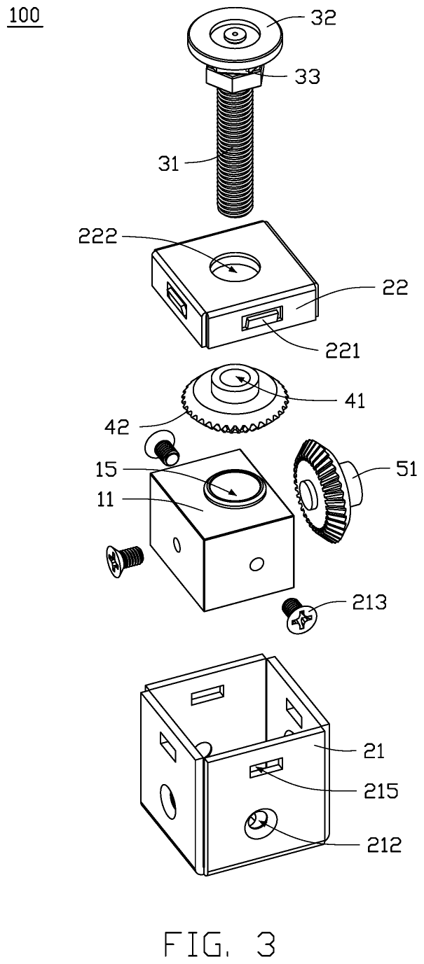

Referring to FIGS. 2 and 3, the fixing base 10 further defines a first installation groove 15 and a second installation groove 16. The first installation groove 15 is recessed in the bottom surface 11. The first installation groove 15 is arranged coaxially with the shaft hole 14, and the diameter of the first installation groove 15 is larger than the diameter of the shaft hole 14 for rotationally connecting the first gear 40.

The second installation groove 16 is recessed in one side surface 13 and used to rotationally connect the second gear 50. The second installation groove 16 extends from a junction of the top surface 12 and the side surface 13 toward the bottom surface 11, so that the second gear 50 can enter the second installation groove 16 from the junction during a mounting process and slide along the second installation groove 16 to adjust a position of the second gear 50. In one embodiment, a length direction of the second installation groove 16 is substantially parallel to the axis of the shaft hole 14.

It is understandable that the fixing base 10 is not limited to a rectangular parallelepiped structure. In other embodiments, the bottom surface 11 and the top surface 12 may have other polygonal shapes.

A gap for accommodating the first gear 40 and the second gear 50 is provided between the fixing base 10 and the housing assembly 20. In one embodiment, the housing assembly 20 includes a casing 21 and a connecting seat 22 that is clamped to an opening of the casing 21. A shape of the casing 21 matches a shape of the fixing base 10.

Specifically, a gap for accommodating the second gear 50 is provided between the casing 21 and the side surface 13 defining the second installation groove 16. The casing 21 defines a first installation hole 211 in a side wall corresponding to the second installation groove 16, and two ends of the second gear 50 are respectively mounted in the second installation groove 16 and the first installation hole 211, so as to rotate between the casing 21 and the side surface 13 defining the second installation groove 16.

In one embodiment, the other side walls of the casing 21 and the corresponding other side surfaces 13 define connecting holes 212 to fix the casing 21 on the fixing base 10 by bolts 213. In other embodiments, the casing 21 and the fixing base 10 are fixed by welding, riveting, nailing, or other suitable fixing methods. The casing 21 defines a through hole 214 in a side wall corresponding to the top surface 12, and the through hole 214 is arranged coaxially with the shaft hole 14 for passing through the support leg 30.

Each side wall of the connecting seat 22 is provided with a latching member 221, and a corresponding latching groove 215 is defined in each side wall of the casing 21. The latching members 221 are latched in the corresponding latching grooves 215 to hold the connecting seat 22 on the opening of the casing 21. A gap for accommodating the first gear 40 is provided between the connecting seat 22 and the bottom surface 11. The connecting seat 22 defines a second installation hole 222, and the second installation hole 222 is arranged coaxially with the shaft hole 14. Two ends of the first gear 40 are respectively installed in the first installation groove 15 and the second installation hole 222 to rotate between the connecting seat 22 and the bottom surface 11.

It can be understood that in other embodiments, the casing 21 and the connecting seat 22 may be fixed together by welding, riveting, nailing, or other suitable fixing methods, or may be integrally formed by molding.

The support leg 30 passes through the shaft hole 14, and one end of the support leg 30 is located outside the housing assembly 20 to support the fixing base 10. Specifically, the support leg 30 passes through the second installation hole 222, the shaft hole 14, and the through hole 214. A thread 31 is provided on a peripheral side of the support leg 30, and the first gear 40 is sleeved on the support leg 30 through the thread 31 and resists against the fixing base 10.

An end of the support leg 30 away from the through hole 214 is provided with a support leg pad 32. In one embodiment, the support leg pad 32 is clamped on the end of the support leg 30, and a side of the support leg pad 32 facing the fixing base 10 forms an arched surface structure to enhance a supporting performance of the support leg pad 32. The support leg 30 is sleeved with a double nut 33, and the side of the support leg pad 32 facing the fixing base 10 is held against the double nut 33 to fix a position of the support leg pad 32 on the support leg 30 and prevent loosening.

In one embodiment, the first gear 40 and the second gear 50 are bevel gears. Specifically, the first gear 40 defines a second shaft hole 41, and an inner wall of the second shaft hole 41 is provided with an internal thread (not shown) that matches with the thread 31 of the support leg 30. An outer thread 42 is provided on an outer side of the first gear 40.

The two ends of the first gear 40 are respectively installed in the first installation groove 15 and the second installation hole 222 to rotate between the connecting seat 22 and the bottom surface 11. The first gear 40 is sleeved on the support leg 30 and is engaged with the support leg 30 through the internal thread. The first gear 40 resists against the fixing base 10. The second gear 50 is rotated to adjust the position of the first gear 40 on the support leg 30 to drive the fixing base 10 to move on the support leg 30. In one embodiment, a washer 223 is provided between the first gear 40 and the second installation hole 222 to facilitate the rotation of the first gear 40.

Two ends of the second gear 50 are respectively installed in the second installation groove 16 and the first installation hole 211 to rotate between the casing 21 and the side surface 13 provided with the second installation groove 16. The second gear 50 meshes with the outer thread 42, and the first gear 40 is driven to rotate by rotation of the second gear 50, thereby driving the fixing base 10 to move on the support leg 30 and adjusting the height of the support stand 100. In one embodiment, an angle between the axis of the first gear 40 and the axis of the second gear 50 is 90°, so that a transmission direction between the first gear 40 and the second gear 50 is 90°, which is different from the existing adjustment nut. Compared with the related art adjustment method, the adjustment is performed on the side wall of the support stand 100, so as to facilitate the operation of adjustment by an operator.

The end of the second gear 50 installed in the first installation hole 211 is provided with an operating portion 51. The operating portion 51 is located outside the casing 21 and facilitates an operator to rotate the second gear 50. In one embodiment, the operating portion 51 is provided with an adjusting hole 511, so that the operating portion 51 is rotated by a wrench inserted in the adjusting hole 511. In other embodiments, the operating portion 51 is a knob.

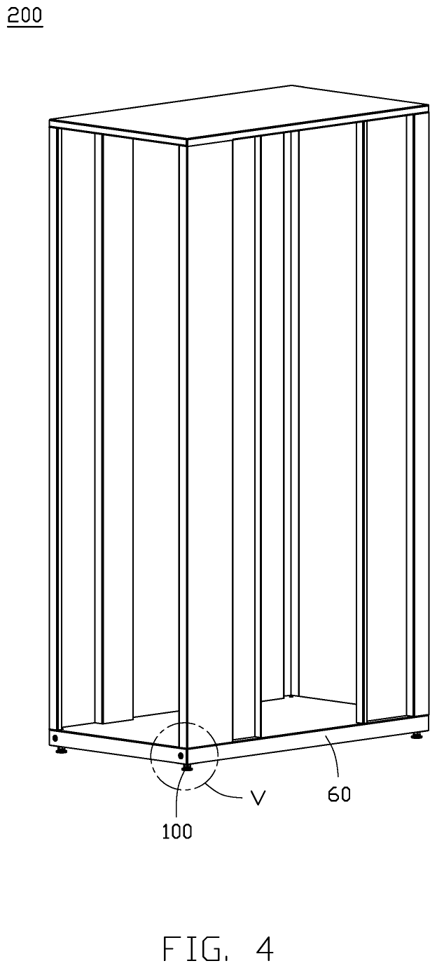

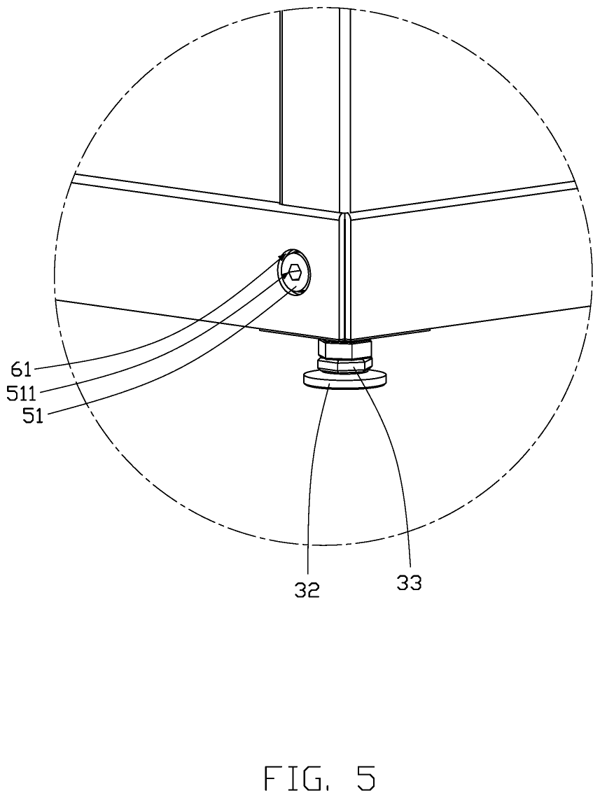

FIG. 4 and FIG. 5 show an embodiment of a cabinet 200 including the above-mentioned support stand 100. The cabinet 200 includes a support plate 60, and a plurality of the support stands 100 is symmetrically arranged on the support plate 60 to support the cabinet 200. The support plate 60 is provided with an operating hole 61, and the operating portion 51 is installed in the operating hole 61 for convenient operation. In one embodiment, the support plate 60 is substantially a rectangular plate, the support stands 100 are symmetrically arranged at the corners of the support plate 60, and the operating portion 51 is installed in the operating hole 61. Thus, the operating portion 51 is directly adjusted from a side of the cabinet 200, thereby adjusting the height of the cabinet 200.

The angle between the axes of the first gear 40 and the second gear 50 is 90°, the first gear 40 is driven by rotation of the second gear 50, the fixing base 10 is driven to move on the support leg 30, and the height of the support stand 100 is adjusted from the side. Compared with the related art adjustment method of adjusting a nut above the support stand, the adjustment method of the present disclosure is more convenient for adjusting the height of the cabinet 200.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A support stand comprising:
a fixing base;
a support leg penetrating through the fixing base;
a housing assembly accommodating the fixing base;
a first gear rotationally sleeved on the support leg and resisting against the fixing base; and
a second gear rotationally mounted between the housing assembly and the fixing base; wherein:
the first gear is meshed with the second gear;
the second gear is provided with an operating portion for rotating the second gear and driving the first gear to rotate, so as to make the first gear move on the support leg and drive the fixing base to move on the support leg.

2. The support stand of claim 1, wherein:
the first gear and the second gear are bevel gears; and
an angle between an axis of the first gear and an axis of the second gear is 90°.

3. The support stand of claim 1, wherein:
an outer surface of the first gear is provided with an outer thread;
the first gear is threadedly sleeved on the support leg; and
the outer thread meshes with the second gear.

4. The support stand of claim 1, wherein:
the fixing base comprises a bottom surface and a top surface;
the bottom surface is opposite to the top surface;
a plurality of side surfaces is arranged between the bottom surface and the top surface;
the fixing base defines a shaft hole passing through the bottom surface and the top surface; and
the support leg passes through the shaft hole and resists against the fixing base by the first gear.

5. The support stand of claim 4, wherein:
the fixing base further defines a first installation groove in the bottom surface;
the first installation groove and the shaft hole are arranged coaxially; and
the first gear is rotationally mounted to the first installation groove.

6. The support stand of claim 5, wherein:
the fixing base further defines a second installation groove in one of the plurality of side surfaces;
the second installation groove extends from a junction of the top surface and the side surface toward the bottom surface; and
the second gear is rotationally mounted in the second installation groove.

7. The support stand of claim 6, wherein:
the housing assembly comprises a casing and a connecting seat clamped on an opening of the casing;
the second gear is accommodated in a gap between the housing and the side surface defining the second installation groove; and
the first gear is accommodated in a gap between the connecting seat and the bottom surface.

8. The support stand of claim 7, wherein:
a first installation hole is defined in a side wall of the housing corresponding to the second installation groove; and
two ends of the second gear are respectively mounted in the second installation groove and the first installation hole.

9. The support stand of claim 8, wherein:
the connecting seat defines a second installation hole coaxially arranged with the shaft hole; and
two ends of the first gear are respectively mounted in the first installation groove and the second installation hole.

10. A cabinet comprising:
a support plate; and
a plurality of support stands symmetrically arranged on the support plate, each support stand comprising:
a fixing base;
a support leg penetrating through the fixing base;
a housing assembly accommodating the fixing base;
a first gear rotationally sleeved on the support leg and resisting against the fixing base; and
a second gear rotationally mounted between the housing assembly and the fixing base; wherein:
the first gear is meshed with the second gear;
the second gear is provided with an operating portion for rotating the second gear and driving the first gear to rotate, so as to make the first gear move on the support leg and drive the fixing base to move on the support leg to adjust a height of the cabinet.

11. The cabinet of claim 10, wherein:
the first gear and the second gear are bevel gears; and
an angle between an axis of the first gear and an axis of the second gear is 90°.

12. The cabinet of claim 10, wherein:
an outer surface of the first gear is provided with an outer thread;
the first gear is threadedly sleeved on the support leg; and
the outer thread meshes with the second gear.

13. The cabinet of claim 10, wherein:
the fixing base comprises a bottom surface and a top surface;
the bottom surface is opposite to the top surface;
a plurality of side surfaces is arranged between the bottom surface and the top surface;
the fixing base defines a shaft hole passing through the bottom surface and the top surface; and
the support leg passes through the shaft hole and resists against the fixing base by the first gear.

14. The cabinet of claim 13, wherein:
the fixing base further defines a first installation groove in the bottom surface;
the first installation groove and the shaft hole are arranged coaxially; and
the first gear is rotationally mounted to the first installation groove.

15. The cabinet of claim 14, wherein:
the fixing base further defines a second installation groove in one of the plurality of side surfaces;
the second installation groove extends from a junction of the top surface and the side surface toward the bottom surface; and
the second gear is rotationally mounted in the second installation groove.

16. The cabinet of claim 15, wherein:
the housing assembly comprises a casing and a connecting seat clamped on an opening of the casing;
the second gear is accommodated in a gap between the housing and the side surface defining the second installation groove; and
the first gear is accommodated in a gap between the connecting seat and the bottom surface.

17. The cabinet of claim 16, wherein:
a first installation hole is defined in a side wall of the housing corresponding to the second installation groove; and
two ends of the second gear are respectively mounted in the second installation groove and the first installation hole.

18. The cabinet of claim 17, wherein:
the connecting seat defines a second installation hole coaxially arranged with the shaft hole; and
two ends of the first gear are respectively mounted in the first installation groove and the second installation hole.
